(19) United States
(12) Patent Application Publication
(10) Pub. No.: US 2024/0190039 A1
(43) Pub. Date: Jun. 13, 2024

(54) Three-Dimensional (3D) Printed Mortar and Preparation Method Therefor, and 3D Printing Method for Mortar

(71) Applicants: Hebei Quantum Intelligent Technology Co., Ltd., Handan City (CN); Hebei Shengzhuo Building Equipment Manufacturing Co., Ltd., Handan City (CN)

(72) Inventors: Chao ZHANG, Handan City (CN); Yi ZHAO, Handan City (CN); Gang LI, Handan City (CN); Ruihua LI, Handan City (CN); Jiawei WANG, Handan City (CN); Chenhui LI, Handan City (CN)

(21) Appl. No.: 18/112,141

(22) Filed: Feb. 21, 2023

(30) Foreign Application Priority Data
Dec. 13, 2022 (CN) 202211592301.9

(51) Int. Cl. B28B 1/00; B33Y 70/10; C04B 7/02; C04B 7/32; C04B 14/06; C04B 16/02; C04B 16/06; C04B 18/06; C04B 18/08; C04B 22/10; C04B 24/12; C04B 24/26; C04B 28/04; C04B 28/06; C04B 40/00

(52) U.S. Cl. CPC B28B 1/001; B33Y 70/10; C04B 7/02; C04B 7/32; C04B 14/06; C04B 16/02; C04B 16/0633; C04B 18/067; C04B 18/08; C04B 22/10; C04B 24/122; C04B 24/2611; C04B 24/2623; C04B 28/04; C04B 28/06; C04B 40/0046; C04B 2103/302

(57) ABSTRACT

The present disclosure belongs to the technical field of mortar, and in particular, to three-dimensional (3D) printed mortar and a preparation method therefor, and a 3D printing method for mortar. The mortar includes: 50-70 parts of ordinary Portland cement; 6-14 parts of sulphoaluminate cement; 2-20 parts of slag powder; 18-22 parts of fly ash; 0.25-2 parts of accelerator; 0.05-0.45 parts of cellulose ether; 0.1-0.3 parts of naphthalene series water reducer; 0.4-0.6 parts of redispersible rubber powder; 0.1-0.5 parts of defoamer; 0.1-0.5 parts of early strength agent; 0.4-1.0 part of polypropylene fiber; 100-120 parts of fine aggregate; and 30-40 parts of water. A 3D printing speed of the mortar of the present disclosure can be stably kept within 150-200 mm/s by using the above raw materials at a reasonable ratio.

### CROSS REFERENCE TO RELATED APPLICATION

This patent application claims the benefit and priority of Chinese Patent Application No. 202211592301.9 filed with the China National Intellectual Property Administration on Dec. 13, 2022, the disclosure of which is incorporated by reference herein in its entirety as part of the present application.

### TECHNICAL FIELD

The present disclosure belongs to the technical field of mortar, and in particular, to three-dimensional (3D) printed mortar and a preparation method therefor, and a 3D printing method for mortar.

### BACKGROUND

At present, 3D printing of mortar has gradually become a research hotspot in the world with its advantages of mold-free intelligent construction. In order to apply this technology widely in the construction industry, researchers around the world have been developing printable mortar suitable for pumping, extrusion and deposition in recent years. In addition, continuous progress has been made in the optimization of its mechanical properties and research on its durability. Therefore, with the increasing popularity of 3D printing technology of mortar, more and more small and medium-sized 3D printed buildings made of in-situ mortar appear in many places in China. However, with the increasing demand for 3D printed buildings, printing materials or printing processes related to printing speed and work efficiency begin to restrict the further development of 3D printing of mortar in China. However, the 3D printing of the current 3D printed mortar is slow. For example, Shi Qingxuan uses ordinary Portland cement and sulphoaluminate cement combined with additives such as a polycarboxylate water reducing agent to prepare the mortar, achieving a maximum printing speed of 150 mm/s.

### SUMMARY

In view of this, the present disclosure provides 3D printed mortar and a preparation method therefor, and a 3D printing method for mortar. 3D printing of the mortar provided by the present disclosure can be completed at a high printing speed.

To achieve the above objective, the present disclosure provides 3D printed mortar, including the following raw materials in parts by mass:
50-70 parts of ordinary Portland cement;
6-14 parts of sulphoaluminate cement;
2-20 parts of slag powder;
18-22 parts of fly ash;
0.25-2 parts of accelerator;
0.05-0.45 parts of cellulose ether;
0.1-0.3 parts of naphthalene series water reducer;
0.4-0.6 parts of redispersible rubber powder;
0.1-0.5 parts of defoamer;
0.1-0.5 parts of early strength agent;
0.4-1.0 part of polypropylene fiber;
100-120 parts of fine aggregate; and
30-40 parts of water.

Preferably, the slag powder has a particle size of 1-75 μm and a specific surface area of 420-450 m²/kg.

Preferably, the fly ash has a density of 2.2-2.3 g/cm³ and a particle size of 1-100 μm.

Preferably, the accelerator includes a lithium carbonate accelerator.

Preferably, the early strength agent includes a triethanolamine early strength agent.

Preferably, the redispersible rubber powder includes vinyl acetate and ethylene copolymer rubber powder.

Preferably, the fine aggregate has a particle size of 0.35-0.5 mm and includes quartz sand.

Preferably, the polypropylene fiber has a length of 5-7 mm and an aspect ratio of 190-210.

The present disclosure further provides a preparation method for the above mortar, including the following steps:
conducting first mixing on the ordinary Portland cement, the sulphoaluminate cement, and the fine aggregate to obtain a first mixture;
conducting second mixing on the slag powder, the fly ash, the polypropylene fiber, the naphthalene series water reducer, the redispersible rubber powder, the cellulose ether, the defoamer, and the accelerator to obtain a second mixture;
conducting third mixing on the early strength agent and the water to obtain an early strength agent solution; and
conducting fourth mixing on the first mixture, the second mixture, and the early strength agent solution to obtain the mortar.

The present disclosure further provides 3D printing using the above mortar. The 3D printing includes the following step: conducting the 3D printing on mortar at 0-35° C. and 0.1-200 mm/s.

The mortar is the above-described mortar.

The present disclosure provides 3D printed mortar, includes the following raw materials in parts by mass: 50-70 parts of ordinary Portland cement; 6-14 parts of sulphoaluminate cement; 2-20 parts of slag powder; 18-22 parts of fly ash; 0.25-2 parts of accelerator; 0.05-0.45 parts of cellulose ether; 0.1-0.3 parts of naphthalene series water reducer; 0.4-0.6 parts of redispersible rubber powder; 0.1-0.5 parts of defoamer; 0.1-0.5 parts of early strength agent; 0.4-1.0 part of polypropylene fiber; 100-120 parts of fine aggregate; and 30-40 parts of water. A 3D printing speed of the mortar of this patent can be stably kept within 150-200 mm/s by taking the ordinary Portland cement, the sulphoaluminate cement, the slag powder, the fly ash, the polypropylene fiber, the naphthalene series water reducer, the redispersible rubber powder, the cellulose ether, the defoamer, accelerator, the early strength agent, and the fine aggregate as the raw materials of the mortar and adopting a reasonable ratio. In addition, the compound influence of additives such as the accelerator, the cellulose ether, and the water reducer can improve the printing speed of the material, and ensure that the 28d compressive strength of the mortar after rapid printing reaches the level of C50. The mortar has high pumpability, high printability and excellent mechanical properties. Using the mortar of the present disclosure for 3D printing can realize rapid printing, reduce the related cost consumption, shorten the product production cycle, and provide guarantee for the future 3D printing industrialization of buildings.

### DETAILED DESCRIPTION OF THE EMBODIMENTS

The present disclosure provides 3D printed mortar, including the following raw materials in parts by mass:
50-70 parts of ordinary Portland cement;
6-14 parts of sulphoaluminate cement;
2-20 parts of slag powder;
18-22 parts of fly ash;
0.25-2 parts of accelerator;
0.05-0.45 parts of cellulose ether;
0.1-0.3 parts of naphthalene series water reducer;
0.4-0.6 parts of redispersible rubber powder;
0.1-0.5 parts of defoamer;
0.1-0.5 parts of early strength agent;
0.4-1.0 part of polypropylene fiber;
100-120 parts of fine aggregate; and
30-40 parts of water.

In the present disclosure, unless otherwise specified, the raw materials used are conventional commercially available products in the field.

In the present disclosure, in parts by mass, the preparation raw materials of the mortar include: 50-70 parts, preferably 55-65 parts, of ordinary Portland cement. In the present disclosure, the strength of the ordinary Portland cement is preferably not less than grade 42.5. In the present disclosure, the ordinary Portland cement preferably includes the following components by mass percentage: 6.65% of Al₂O₃, 58.93% of CaO, 2.54% of SO₃, 24.12% of SiO₂, 3.78% of Fe₂O₃, and 0.79% of MgO, and has a loss on ignition (Loss) of preferably 3.19%. The present disclosure makes use of the low hydrothermal characteristics of Portland cement, which can ensure that the volume shrinkage of the printed material is controlled in a small range in the process of moisture losing and setting, and finally effectively prevent the early cracking of mortar during setting.

In the present disclosure, in parts by mass, the preparation raw materials of the mortar include: 6-14 parts, preferably 10-12 parts, of sulphoaluminate cement. In the present disclosure, the sulphoaluminate cement preferably includes the following components by mass percentage: 35.17% of Al₂O₃, 42.54% of CaO, 10.79% of SO₃, 6.13% of SiO₂, 1.53% of Fe₂O₃, and 1.24% of MgO, and has a loss on ignition (Loss) of preferably 2.6%. The present disclosure realizes rapid setting using the sulphoaluminate cement and has specific properties of early strength. In combination with the ordinary Portland cement, the gel time of the mortar is controlled, and the mechanical properties and durability of the printed mortar are also ensured.

In the present disclosure, in parts by mass, the preparation raw materials of the mortar include: 2-20 parts, preferably 10-15 parts, of slag powder. In the present disclosure, the slag powder is preferably S95 slag powder and/or S105 slag powder. In the present disclosure, the slag powder is preferably granulated blast furnace slag. In the present disclosure, the slag powder preferably includes the following components by mass percentage: 33.62% of Al₂O₃, 4.118% of CaO, 2.72% of SO₃, 42.33% of SiO₂, 9.064% of Fe₂O₃, and 4.664% of MgO, and has a loss on ignition (Loss) of preferably 3.484%. In the present disclosure, the slag powder has a particle size of preferably 1-75 m, more preferably 1-45 μm. In the present disclosure, the slag powder has a specific surface area of 420-450 m²/kg, more preferably 440 m²/kg. In the example of the present disclosure, specifically, the slag powder is preferably S95 slag powder with a specific surface area of 440 m²/kg produced by Xi'an Delong New Building Material Technology Co., Ltd. In the present disclosure, the printability and mechanical properties of 3D printing materials can be effectively improved and the cost of concrete can be reduced by using the characteristics of slag powder. In addition, a reasonable proportion of slag powder can reduce the rate of hydration hardening and heating, reduce the early temperature cracks in the 3D printing structure of the mortar, improve the concrete compactness, and ensure the stability of 3D printing of the mortar in the rapid printing process.

In the present disclosure, in parts by mass, the preparation raw materials of the mortar include: 18-22 parts, preferably 19-20 parts, of fly ash. In the present disclosure, the fly ash has a particle size of preferably 1-100 m, more preferably 20-80 μm. In the present disclosure, the fly ash has a density of preferably 2.2-2.3 g/cm³, more preferably 2.24 g/cm³. In the present disclosure, the grade of the fly ash is preferably Chinese national first-grade fly ash. In the present disclosure, the fly ash preferably includes the following components by mass percentage: 19.22% of Al₂O₃, 34.37% of CaO, 6.98% of SO₃, 33.46% of SiO₂, 1.02% of Fe₂O₃, 0.293% of MgO, and 0.833% of TiO₂, and has a loss on ignition (Loss) of preferably 3.824%. The present disclosure makes use of the characteristics of the composition and fineness of the fly ash, which can trigger the active effect to generate cementitious substances such as calcium silicate hydrate and calcium aluminate hydrate. In addition, since the fly ash has an extremely small particle size, the rheological property of the whole cementitious material is increased, the uniformity and compactness are improved, and the structural strength of 3D printing products of the mortar is improved.

In the present disclosure, in parts by mass, the preparation raw materials of the mortar include: 0.25-2 parts, preferably 0.5-1.5 parts, of accelerator. In the present disclosure, the accelerator preferably includes a lithium carbonate accelerator. The present disclosure uses the accelerator and aluminum oxygen clinker (sulphoaluminate cement), which can play a high speed setting effect, improve the setting time of the mortar, and realize rapid printing.

In the present disclosure, in parts by mass, the preparation raw materials of the mortar include: 0.05-0.45 parts, preferably 0.10-0.4 parts, of cellulose ether. In the present disclosure, specifically, the cellulose ether is preferably cellulose ether of 200,000 viscosity provided by Shandong Ruitai Chemical Co., Ltd. The present disclosure makes use of the structural characteristics of polymer ether of cellulose ether to ensure the formation of a film between cellulose ether and hydrated cement particles, so as to prevent water seepage, improve the water retention and workability of the mortar, and thus improve the interlayer adhesion of 3D printing products of the mortar. In addition, the high efficiency of water retention and thickening of cellulose ether reduces the reaction rate of hydration reaction, which can achieve a certain degree of retarding function for the mortar during printing, can control the setting time of the mortar during the 3D printing when reflected in the time work, and improve the operability of 3D printing of the mortar.

In the present disclosure, in parts by mass, the preparation raw materials of the mortar include: 0.1-0.3 parts, preferably 0.15-0.25 parts, of naphthalene series water reducer. In the present disclosure, the naphthalene series water reducer has a water-reducing rate of 20-25%. In the present disclosure, specifically, the naphthalene series water reducer is preferably a CQJ-NX01 naphthalene series water reducer produced by Shanghai Chenqi Chemical Technology Co., Ltd. The present disclosure makes use of the high water-reducing rate of the naphthalene series water reducer to improve the fluidity of the mortar during 3D printing. Due to the addition of the naphthalene series water reducer, the content of mixing water is reduced on a year-on-year basis, the water-binder ratio is increased, and the mechanical strength and durability of 3D printing products of mortar are finally improved.

In the present disclosure, in parts by mass, the preparation raw materials of the mortar include: 0.4-0.6 parts, preferably 0.5-0.55 parts, of redispersible rubber powder. In the present disclosure, the redispersible rubber powder is preferably vinyl acetate and ethylene copolymer rubber powder, and the protective colloid in the vinyl acetate and ethylene copolymer rubber powder is preferably polyvinyl alcohol. In the present disclosure, the redispersible rubber powder is preferably German Wacker 5010N type redispersible latex powder. The present disclosure can improve the fluidity of the mortar during 3D printing by using the characteristics of polyvinyl alcohol.

In the present disclosure, in parts by mass, the preparation raw materials of the mortar include: 0.1-0.5 parts, preferably 0.2-0.4 parts, of defoamer. In the present disclosure, the defoamer preferably includes a polyether polyol defoamer, and the composition of the polyether polyol defoamer preferably includes liquid hydrocarbons and polyethylene glycol. In the example of the present disclosure, specifically, the defoamer is preferably a P-893 type defoamer provided by MUNZING of Germany. The present disclosure uses the defoamer to eliminate a large number of bubbles in the printed material caused by adding the naphthalene series water reducer to the mortar, so as to improve the compressive strength of the mortar and improve the surface state.

In the present disclosure, in parts by mass, the preparation raw materials of the mortar include: 0.1-0.5 parts, preferably 0.2-0.4 parts, of early strength agent. In the present disclosure, the early strength agent preferably includes a triethanolamine early strength agent. The present disclosure uses the early strength agent to improve the hydration speed of cement, promote the development of early strength of the mortar, establish the early strength, and ensure rapid printing of the mortar.

In the present disclosure, in parts by mass, the preparation raw materials of the mortar include: 0.4-1.0 part, preferably 0.5-0.8 parts, of polypropylene fiber. In the present disclosure, the polypropylene fiber has a length of preferably 5-7 mm, more preferably 6 mm and an aspect ratio of preferably 190-210, more preferably 200. The present disclosure can improve the structural strength and durability of 3D printing products of the integral mortar by utilizing the thickening effect of the polypropylene fiber and the mechanical compensation of micro-cracks.

In the present disclosure, in parts by mass, the preparation raw materials of the mortar include: 100-120 parts, preferably 110-115 parts, of fine aggregate. In the present disclosure, the fine aggregate preferably includes quartz sand. In the present disclosure, the quartz sand preferably includes the following components by mass percentage: 98.2% of SiO₂ and 0.02% of Fe₂O₃. In the present disclosure, the quartz sand has refractoriness of preferably 1,700° C., homogeneity of preferably 90%, hardness of preferably 6.7, and a water content of preferably 1%. In the present disclosure, the fine aggregate has a particle size of 0.35-0.5 mm, preferably 0.4-0.45 mm. In the present disclosure, the fine aggregate has a fineness modulus of preferably 0.23-0.3, more preferably 0.25-0.28. The present disclosure uses the fine aggregate mainly to reduce cost, inhibit shrinkage and prevent cracking, so as to ensure that self-shrinking cracks can be reduced during and after printing of the mortar with a higher content of sulphoaluminate cement, and the mechanical properties and durability of 3D printing products are not affected.

In the present disclosure, in parts by mass, the preparation raw materials of the mortar include: 30-40 parts, preferably 32-35 parts, of water.

The present disclosure further provides a preparation method for the above mortar, including the following steps.

First mixing is conducted on the ordinary Portland cement, the sulphoaluminate cement, and the fine aggregate to obtain a first mixture.

Second mixing is conducted on the slag powder, the fly ash, the polypropylene fiber, the naphthalene series water reducer, the redispersible rubber powder, the cellulose ether, the defoamer, and the accelerator to obtain a second mixture.

Third mixing is conducted on the early strength agent and the water to obtain an early strength agent solution.

Fourth mixing is conducted on the first mixture, the second mixture, and the early strength agent solution to obtain the mortar.

In the present disclosure, the first mixing and the second mixing methods independently preferably include stirring at preferably 55-65 rpm, more preferably 60 rpm, for preferably 2-3 min.

In the present disclosure, the third mixing method independently preferably includes stirring at preferably 55-65 rpm, more preferably 60 rpm, for preferably 5-10 min.

In the present disclosure, the fourth mixing method independently preferably includes stirring at preferably 55-65 rpm, more preferably 60 rpm, for preferably 5-10 min. In the present disclosure, during the third mixing, stirring is conducted preferentially to a state of uniform viscous slurry.

The preparation method of the present disclosure can ensure the full and uniform distribution of two main cementitious materials (the ordinary Portland cement and sulphoaluminate cement) and the fine aggregate in the dry powder state, and can also ensure that both the powder additive and the solution additive can be fully mixed in the first mixture, so as to ensure that the performance of the prepared mortar is more stable. Moreover, the preparation process is simple, convenient and practical, and can ensure the stable preparation and efficient output of the mortar described in the patent.

The present disclosure further provides a method for 3D printing using the above mortar, preferably including the following step.

The 3D printing is conducted on the mortar.

In the present disclosure, the 3D printing is conducted at 0-35° C., more preferably 20-30° C., and 0.1-200 mm/s, more preferably 150-200 mm/s.

In the present disclosure, the mortar after 3D printing is stored at preferably 0-40° C., more preferably 20-30° C.

The technical solutions provided by the present disclosure are described in detail below in combination with the examples, but they cannot be understood as limiting the protection scope of the present disclosure.

In the present disclosure, the slag powder in the example is S95 slag powder with a specific surface area of 440 m²/kg produced by Xi'an Delong New Building Material Technology Co., Ltd.

The fly ash has a density of 2.24 g/cm³, and the fly ash preferably includes the following components by mass percentage: 19.22% of Al₂O₃, 34.37% of CaO, 6.98% of SO₃, 33.46% of SiO₂, 1.02% of Fe₂O₃, 0.293% of MgO, and 0.833% of TiO₂, and has a loss on ignition (Loss) of 3.824%.

The cellulose ether is cellulose ether of 200,000 viscosity provided by Shandong Ruitai Chemical Co., Ltd.

The naphthalene series water reducer is a CQJ-NX01 naphthalene series water reducer produced by Shanghai Chenqi Chemical Technology Co., Ltd.

The redispersible rubber powder is German Wacker 5010N type redispersible latex powder.

The defoamer is a P-893 type defoamer provided by MUNZING of Germany.

The early strength agent is a triethanolamine early strength agent.

The polypropylene fiber has a length of 6 mm and an aspect ratio of 200.

The fine aggregate is quartz sand. The quartz sand has a particle size of 0.35-0.5 mm, and a fineness modulus of 0.23-0.3. The components of the quartz sand include 98.2% of SiO₂ and 0.02% of Fe₂O₃.

### Example 1

The mortar included: 60 parts of ordinary Portland cement, 6 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 2

The mortar included: 60 parts of ordinary Portland cement, 8 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 3

The mortar included: 60 parts of ordinary Portland cement, 10 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 4

The mortar included: 60 parts of ordinary Portland cement, 12 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 5

The mortar included: 60 parts of ordinary Portland cement, 14 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 6

The mortar included: 70 parts of ordinary Portland cement, 10 parts of sulphoaluminate cement, 2 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 7

The mortar included: 65 parts of ordinary Portland cement, 10 parts of sulphoaluminate cement, 5 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 8

The mortar included: 55 parts of ordinary Portland cement, 10 parts of sulphoaluminate cement, 15 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 9

The mortar included: 50 parts of ordinary Portland cement, 10 parts of sulphoaluminate cement, 20 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 10

The mortar included: 70 parts of ordinary Portland cement, 10 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 11

The mortar included: 50 parts of ordinary Portland cement, 10 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 12

The mortar included: 45 parts of ordinary Portland cement, 10 parts of sulphoaluminate cement, 10 parts of slag powder, 20 parts of fly ash, 1 part of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 13

The mortar included: 60 parts of ordinary Portland cement, 10 parts of sulphoaluminate cement, 10 parts of slag powder, 20 parts of fly ash, 0.25 parts of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 14

The mortar included: 60 parts of ordinary Portland cement, 10 parts of sulphoaluminate cement, 10 parts of slag powder, 20 parts of fly ash, 0.5 parts of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 15

The mortar included: 60 parts of ordinary Portland cement, 10 parts of sulphoaluminate cement, 10 parts of slag powder, 20 parts of fly ash, 1.5 parts of lithium carbonate accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 16

The mortar included: 60 parts of ordinary Portland cement, 10 parts of sulphoaluminate cement, 10 parts of slag powder, 20 parts of fly ash, 2 parts of accelerator, 0.15 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of fine aggregate, and 32 parts of water.

### Example 17

The mortar included: 60 parts of ordinary Portland cement, 10 parts of sulphoaluminate cement, 10 parts of slag powder, 20 parts of fly ash, 1 part of lithium carbonate accelerator, 0.05 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 18

The mortar included: 60 parts of ordinary Portland cement, 10 parts of sulphoaluminate cement, 10 parts of slag powder, 20 parts of fly ash, 1 part of lithium carbonate accelerator, 0.25 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 19

The mortar included: 60 parts of ordinary Portland cement, 10 parts of sulphoaluminate cement, 10 parts of slag powder, 20 parts of fly ash, 1 part of lithium carbonate accelerator, 0.35 parts of cellulose ether, 0.15 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Example 20

The mortar included: 60 parts of ordinary Portland cement, 10 parts of sulphoaluminate cement, 10 parts of slag powder, 20 parts of fly ash, 1 part of accelerator, 0.15 parts of cellulose ether, 0.45 parts of naphthalene series water reducer, 0.5 parts of redispersible rubber powder, 0.25 parts of defoamer, 0.25 parts of early strength agent, 0.5 parts of polypropylene fiber, 110 parts of quartz sand, and 32 parts of water.

### Comparative Example 1

The difference from Example 3 was only that there was 0 parts of naphthalene series water reducer.

### Comparative Example 2

The difference from Example 3 was only that there was 0 parts of redispersible rubber powder.

### Comparative Example 3

The difference from Example 3 was only that there was 0 parts of defoamer.

### Comparative Example 4

The difference from Example 3 was only that there was 0 parts of early strength agent.

### Comparative Example 5

The difference from Example 3 was only that there was 0 parts of polypropylene fiber.

The mortar preparation raw materials in Examples 1 to 20 and Comparative Examples 1 to 5 were prepared into the mortar according to the following preparation method. The preparation method included the following steps.

The ordinary Portland cement, the sulphoaluminate cement, and the quartz sand were mixed at 60 rpm for 3 min to obtain a first mixture.

The slag powder, the fly ash, the polypropylene fiber, the naphthalene series water reducer, the redispersible rubber powder, the cellulose ether, the defoamer, and the lithium carbonate accelerator were mixed at 60 rpm for 3 min to obtain a second mixture.

The early strength agent and the water were mixed at 55-65 rpm for 5-10 min to obtain an early strength agent solution.

The first mixture, the second mixture, and the early strength agent solution were mixed at 60 rpm for 5 min to obtain the mortar.

The present disclosure tested the physical and chemical properties of mortar prepared from Examples 1 to 20. For the test standards, reference may be made to “Standard for test method of basic properties of construction mortar (JGJ70-2009)”, “Test method for fluidity of cement mortar (GB/T2419-2005)”, and “Test method of cement mortar strength (GB/T 17671-2021)”. The test results are shown in Table 1 to Table 6.

TABLE 1
Statistic of physical and chemical properties of mortar in Examples 1 to 5

| | | | | 1d | 1d | 28d | 28d |
|---|---|---|---|---|---|---|---|
| Experimental | Setting | | | compressive | flexural | compressive | flexural |
| group | time | Consistency | Fluidity | strength | strength | strength | strength |
| Unit | min | mm | mm | Mpa | Mpa | Mpa | Mpa |
| Example 1 | 9′20″ | 65 | 186 | 24.975 | 4.3 | 51.2 | 8.6 |
| Example 2 | 8′43″ | 65 | 190 | 26.8 | 4.5 | 52.5 | 8.9 |
| Example 3 | 8′19″ | 67 | 187 | 27 | 5.0 | 54.0 | 10.5 |
| Example 4 | 7′49″ | 63 | 171 | 28.9 | 4.8 | 54.7 | 8.8 |
| Example 5 | 6′45″ | 69 | 167 | 29.8 | 5.0 | 55.5 | 9.2 |

As can be seen from Table 1: on the premise of not modifying other variables, increasing the percentage of the sulphoaluminate cement can shorten the setting time of the mortar during the 3D printing, and provide guarantee for rapid 3D printing of the mortar in the patent. The consistency, fluidity and mechanical properties have little change and there is no obvious rule. 6-14 parts of sulphoaluminate cement are added. The 3D printed mortar with ideal consistency and fluidity can be obtained in combination with a reasonable ratio range of the raw materials of Examples 1 to 20 to meet the 3D printing.

TABLE 2
Statistic of physical and chemical properties of mortar in Example
3 and Examples 6 to 9

| | | | | 1d | 1d | 28d | 28d |
|---|---|---|---|---|---|---|---|
| Experimental | Setting | | | compressive | flexural | compressive | flexural |
| group | time | Consistency | Fluidity | strength | strength | strength | strength |
| Unit | min | mm | mm | Mpa | Mpa | Mpa | Mpa |
| Example 3 | 8′19″ | 67 | 187 | 27.0 | 5.0 | 54.0 | 10.5 |
| Example 6 | 6′59″ | 59 | 169 | 23.9 | 4.5 | 47.4 | 9.0 |
| Example 7 | 7′56″ | 64 | 171 | 25.4 | 4.9 | 50.3 | 9.7 |
| Example 8 | 8′45″ | 75 | 190 | 26.1 | 5.2 | 47.3 | 10.4 |
| Example 9 | 9′00″ | 80 | 197 | 23.6 | 4.6 | 47.1 | 9.1 |

As can be seen from Table 2: on the premise of not modifying other variables, increasing the percentage of the slag powder can improve the consistency and fluidity of the mortar, and provide guarantee for rapid 3D printing of the mortar in the patent. The setting time and mechanical properties have little change and there is no obvious rule. 2-20 parts of slag powder are added. The 3D printed mortar with ideal consistency and fluidity can be obtained in combination with a reasonable ratio range of the raw materials of Examples 1 to 20 to meet the 3D printing.

TABLE 3
Statistic of physical and chemical properties of mortar in Example
3 and Examples 10 to 12

| | | | | 1d | | 28d | |
|---|---|---|---|---|---|---|---|
| Experimental | | | | compressive | 1d flexural | compressive | 28d flexural |
| group | Setting time | Consistency | Fluidity | strength | strength | strength | strength |
| Unit | min | mm | mm | Mpa | Mpa | Mpa | Mpa |
| Example 3 | 8′19″ | 67 | 187 | 27.0 | 5.0 | 54.0 | 10.5 |
| Example 10 | 8′00″ | 67 | 189 | 25.3 | 4.9 | 51.8 | 9.7 |
| Example 11 | 11′32″ | 77 | 198 | 22.2 | 4.1 | 45.0 | 8.2 |
| Example 12 | 12′34″ | 83 | 210 | 22.3 | 4.2 | 45.0 | 8.4 |

It can be seen from results in Table 3 that on the premise of not modifying other variables, increasing the percentage of the fly ash can improve the consistency and fluidity of the mortar, and provide guarantee for rapid 3D printing of the mortar in the patent. The setting time and mechanical properties have little change and there is no obvious rule. 2-20 parts of slag powder are added. The 3D printed mortar with ideal consistency and fluidity can be obtained in combination with a reasonable ratio range of the raw materials of Examples 1 to 20 to meet the 3D printing.

TABLE 4
Statistic of physical and chemical properties of mortar in Example 3 and Examples
13 to 16

| | | | | 1d | | 28d | |
|---|---|---|---|---|---|---|---|
| Experimental | | | | compressive | 1d flexural | compressive | 28d flexural |
| group | Setting time | Consistency | Fluidity | strength | strength | strength | strength |
| Unit | min | mm | mm | Mpa | Mpa | Mpa | Mpa |
| Example 3 | 8′19″ | 67 | 187 | 27.0 | 5.0 | 54.0 | 10.5 |
| Example 13 | 9′25″ | 67 | 188 | 21.8 | 4.1 | 45.8 | 8.9 |
| Example 14 | 9′00″ | 63 | 183 | 24.3 | 5.1 | 47.0 | 9.6 |
| Example 15 | 7′09″ | 68 | 185 | 18.8 | 3.6 | 45.0 | 9.0 |
| Example 16 | 6′35″ | 67 | 179 | 18.0 | 3.4 | 35.9 | 7.6 |

It can be seen from results in Table 4 that on the premise of not modifying other variables, increasing the percentage of the accelerator can shorten the setting time of the mortar during the 3D printing. The consistency, fluidity and mechanical properties have little change and there is no obvious rule, which provides guarantee for rapid 3D printing of the mortar in the patent. The setting time and mechanical properties have little change and there is no obvious rule. 0.5-2 parts of accelerator are added. The 3D printed mortar with ideal consistency and fluidity can be obtained in combination with a reasonable ratio range of the raw materials of Examples 1 to 20. However, when the content of the accelerator is 200, other raw materials need to be adjusted to meet the higher 28D mechanical properties and achieve the objective of the patent.

TABLE 5
Statistic of physical and chemical properties of mortar in Example 3 and Examples
17 to 20

| | | | | 1d | | | |
|---|---|---|---|---|---|---|---|
| Experimental | Setting | | | compressive | 1d flexural | 28d compressive | 28d flexural |
| group | time | Consistency | Fluidity | strength | strength | strength | strength |
| Unit | min | mm | mm | Mpa | Mpa | Mpa | Mpa |
| Example 3 | 8′19″ | 67 | 187 | 27.0 | 5.0 | 54.0 | 10.5 |
| Example 17 | 8′10″ | 62 | 171 | 28.8 | 5.6 | 54.0 | 10.4 |
| Example 18 | 8′47″ | 75 | 191 | 22.4 | 4.2 | 48.5 | 7.5 |
| Example 19 | 9′11″ | 79 | 197 | 21.4 | 4.1 | 49.4 | 7.7 |
| Example 20 | 9′49″ | 85 | 206 | 20.0 | 3.9 | 45.2 | 6.9 |

Note: ′ represents an initial setting time, and ″ represents a final setting time.

It can be seen from results in Table 5 that on the premise of not modifying other variables, increasing the percentage of the cellulose ether can improve the consistency and fluidity of the mortar, and provide guarantee for rapid 3D printing of the mortar in the patent. In addition, the mechanical properties have little change and there is no obvious rule, but the setting time decreases with the increase of the cellulose ether composition. This is because the polymer ether structure of the cellulose ether forms a film between the cellulose ether and hydrated cement particles, which improves the water retention, but has a certain inhibitory effect on the premise hydration reaction, resulting in a slight increase in the setting time. 2-20 parts of cellulose ether are added. The 3D printed mortar with ideal consistency and fluidity can be obtained in combination with a reasonable ratio range of the raw materials of Examples 1 to 20. However, other raw materials need to be adjusted in the ratio to meet shorter setting time and achieve the objective of the patent.

TABLE 6
Statistic of physical and chemical properties of mortar in Example 3 and
Comparative Examples 1 to 5

| | | | | 1d | 1d | 28d | 28d |
|---|---|---|---|---|---|---|---|
| Experimental | Setting | | | compressive | flexural | compressive | flexural |
| group | time | Consistency | Fluidity | strength | strength | strength | strength |
| Unit | min | mm | mm | Mpa | Mpa | Mpa | Mpa |
| Example 3 | 8′19″ | 67 | 187 | 36.1 | 6.7 | 72.1 | 13.9 |
| Comparative | 9′19″ | 40 | 132 | 23.4 | 4.7 | 46.5 | 8.9 |
| Example 1 | | | | | | | |
| Comparative | 8′23″ | 56 | 136 | 36.1 | 6.7 | 72.1 | 13.9 |
| Example 2 | | | | | | | |
| Comparative | 7′59″ | 59 | 186 | 27.5 | 5.5 | 59.4 | 8.9 |
| Example 3 | | | | | | | |
| Comparative | 8′23″ | 63 | 177 | 19.9 | 3.8 | 66.6 | 11.8 |
| Example 4 | | | | | | | |
| Comparative | 7′55″ | 55 | 199 | 26.1 | 4.7 | 42.1 | 7.9 |
| Example 5 | | | | | | | |

As can be seen from Table 6, there are inconformity items in a properties of the mortar in Comparative Examples 1 to 5, which cannot meet the relevant requirements. Therefore, the percentages of various compositions affect the rapid printing requirements during the 3D printing in the patent or the mechanical properties of the printed products of the mortar.

The present disclosure conducts 3D printing on the mortar prepared by Examples 1 to 20, and uses the two-point timing method to test the actual speed of 3D printing. That is, the actual printing speed can be obtained by dividing the distance between two points by the printing time. According to statistics, Examples 1 to 20 can complete the printing task within the printing speed range of 150-200 mm/s, which improves the 3D printing speed of the mortar.

The above is only the preferred implementation of the present disclosure. It should be noted that for those of ordinary skill in the art, several improvements and modifications can be made without departing from the principle of the present disclosure, and these improvements and modifications shall also be considered as the scope of protection of the present disclosure.

What is claimed is:

1. Three-dimensional (3D) printed mortar, comprising the following raw materials in parts by mass:
50-70 parts of ordinary Portland cement;
6-14 parts of sulphoaluminate cement;
2-20 parts of slag powder;
18-22 parts of fly ash;
0.25-2 parts of accelerator;
0.05-0.45 parts of cellulose ether;
0.1-0.3 parts of naphthalene series water reducer;
0.4-0.6 parts of redispersible rubber powder;
0.1-0.5 parts of defoamer;
0.1-0.5 parts of early strength agent;
0.4-1.0 part of polypropylene fiber;
100-120 parts of fine aggregate; and
30-40 parts of water.

2. The mortar according to claim 1, wherein the slag powder has a particle size of 1-75 m and a specific surface area of 420-450 m²/kg.

3. The mortar according to claim 1, wherein the fly ash has a density of 2.2-2.3 g/cm³ and a particle size of 1-100 μm.

4. The mortar according to claim 1, wherein the accelerator comprises a lithium carbonate accelerator.

5. The mortar according to claim 1, wherein the early strength agent comprises a triethanolamine early strength agent.

6. The mortar according to claim 1, wherein the redispersible rubber powder comprises vinyl acetate and ethylene copolymer rubber powder.

7. The mortar according to claim 1, wherein the fine aggregate has a particle size of 0.35-0.5 mm and comprises quartz sand.

8. The mortar according to claim 1, wherein the polypropylene fiber has a length of 5-7 mm and an aspect ratio of 190-210.

9. A preparation method for the mortar according to claim 1, comprising the following steps:
conducting first mixing on the ordinary Portland cement, the sulphoaluminate cement, and the fine aggregate to obtain a first mixture;
conducting second mixing on the slag powder, the fly ash, the polypropylene fiber, the naphthalene series water reducer, the redispersible rubber powder, the cellulose ether, the defoamer, and the accelerator to obtain a second mixture;
conducting third mixing on the early strength agent and the water to obtain an early strength agent solution; and
conducting fourth mixing on the first mixture, the second mixture, and the early strength agent solution to obtain the mortar.

10. The preparation method for the mortar according to claim 9, wherein the slag powder has a particle size of 1-75 μm and a specific surface area of 420-450 m²/kg.

11. The preparation method for the mortar according to claim 9, wherein the fly ash has a density of 2.2-2.3 g/cm³ and a particle size of 1-100 μm.

12. The preparation method for the mortar according to claim 9, wherein the accelerator comprises a lithium carbonate accelerator.

13. The preparation method for the mortar according to claim 9, wherein the early strength agent comprises a triethanolamine early strength agent.

14. The preparation method for the mortar according to claim 9, wherein the redispersible rubber powder comprises vinyl acetate and ethylene copolymer rubber powder.

15. The preparation method for the mortar according to claim 9, wherein the fine aggregate has a particle size of 0.35-0.5 mm and comprises quartz sand.

16. The preparation method for the mortar according to claim 9, wherein the polypropylene fiber has a length of 5-7 mm and an aspect ratio of 190-210.

17. A 3D printing method using the mortar according to claim 1, wherein the 3D printing comprises the following step: conducting the 3D printing on the mortar at 0-35° C. and 0.1-200 mm/s; and
the mortar is the mortar according to claim 1.

18. The 3D printing method using the mortar according to claim 17, wherein the slag powder has a particle size of 1-75 μm and a specific surface area of 420-450 m²/kg.

19. The 3D printing method using the mortar according to claim 17, wherein the fly ash has a density of 2.2-2.3 g/cm³ and a particle size of 1-100 μm.

20. The 3D printing method using the mortar according to claim 17, wherein the accelerator comprises a lithium carbonate accelerator.
